(19) United States
(12) Patent Application Publication
(10) Pub. No.: US 2021/0265902 A1
(43) Pub. Date: Aug. 26, 2021

(54) LINEAR MOTOR WITH FLANGE MAGNETIC YOKE NESTED IN COIL

(71) Applicant: LEADING TECHNOLOGY (DONGTAI) CO., LTD, Yancheng (CN)

(72) Inventors: Lei WANG, Yancheng (CN); Zhifeng LI, Yancheng (CN); Shaoqian GUO, Yancheng (CN)

(73) Assignee: LEADING TECHNOLOGY (DONGTAI) CO., LTD, Yancheng (CN)

(21) Appl. No.: 17/058,666

(22) PCT Filed: Sep. 16, 2019
(86) PCT No.: PCT/CN2019/105955

§ 371 Date: Nov. 25, 2020

(30) Foreign Application Priority Data
Aug. 28, 2019 (CN) 201910799976.2

(51) Int. Cl. H02K 33/02; B06B 1/04; H02K 33/18

(52) U.S. Cl. CPC H02K 33/02; H02K 33/18; B06B 1/045

(57) ABSTRACT

A linear motor with a flange magnetic yoke nested in a coil is provided, including an enclosure. A mover assembly and a stator assembly correspondingly cooperating with the mover assembly are arranged in the enclosure. The stator assembly includes a coil and an FPC board for connecting the coil with an external circuit. A flange magnetic yoke is nested in the coil. The mover assembly is provided with a permanent magnet correspondingly matched with the coil. An end of the flange magnetic yoke is provided with a third flanged edge matched with the coil. The third flanged edge is provided with, in a circumferential direction thereof, at least one second notch matched with the coil. The flange magnetic yoke increases a magnetic conductivity of an overall magnetic circuit and enhance a magnetic induction intensity on the coil.

### CROSS-REFERENCE TO THE RELATED APPLICATIONS

This application is the national stage entry of International Application No. PCT/CN2019/105955, filed on Sep. 16, 2019, which is based upon and claims priority to Chinese Patent Application No. 201910799976.2, filed on Aug. 28, 2019, the entire contents of which are incorporated herein by reference.

### TECHNICAL FIELD

The present disclosure relates to the technical field of motors, and more particularly relates to a linear motor with a flange magnetic yoke nested in a coil.

### BACKGROUND

With the rapid development of electronic products, especially mobile terminal devices such as mobile phones and tablet computers, these electronic devices basically adopt vibration generation devices to prevent noise from the electronic devices from interfering with other people. A traditional vibration generation device adopts an eccentric-rotation-based rotor motor. The rotor motor realizes mechanical vibration through the rotation of an eccentric vibrator. Since a commutator and an electric brush will generate mechanical friction, electric sparks and the like in the rotation process of the electric vibrator, the rotation speed of the eccentric vibrator will be affected, and then the vibration effect of the device will be affected. Therefore, the vibration generation device mostly adopts a linear motor with better performance.

The linear motor is also known as a linear electric motor, a straight-line motor, a push rod motor, etc. The most commonly used linear motor is in a flat plate type, a U-groove type motors and a tubular type, is based on a technology that converts electrical energy into mechanical energy of linear motion, and is capable of making a moving element suspend by means of repulsive forces of magnets and directly driving the moving element by means of a magnetic force. The linear motor does not need to be driven like a rotary motor which is driven by a transmission mechanism such as a gear set. Therefore, the linear motor can make the moving element driven by the linear motor does high-acceleration/deceleration reciprocating motion. With this characteristic, the linear motor can be used in different manufacturing and machining technical fields, and used as a power source for driving or used as a technical content for providing localization. In addition, with the rapid development and fierce competition of semiconductor, electronics, optoelectronics, medical equipment, automation control and other industries, the requirements of various fields on the linear motion performance of motors are also increasing. It is expected that motors have high speed, low noise, high positioning accuracy and the like. Therefore, linear motors have been used in many application scenes to replace traditional servo motors and other mechanical motion methods.

However, some of the existing linear motors have certain deficiencies in their design, which lead to problems such as small vibration force, large space occupation, and poor stability and reliability, thereby reducing the vibration effects of the motors and affecting the application and development of the motors.

### SUMMARY

The present disclosure provides a linear motor with a flange magnetic yoke nested in a coil for the problems in the existing linear motors.

In order to solve at least one of the above technical problems, the present disclosure provides the following technical solution:

A linear motor with a flange magnetic yoke nested in a coil includes an enclosure. A mover assembly and a stator assembly correspondingly cooperating with the mover assembly are arranged in the enclosure; the stator assembly includes a coil and an FPC board for connecting the coil with an external circuit; a flange magnetic yoke is nested in the coil; the mover assembly is provided with a permanent magnet correspondingly matched with the coil; the end, close to the permanent magnet, of the flange magnetic yoke is provided with a third flanged edge matched with the coil; and the third flanged edge is provided with, in a circumferential direction thereof, at least one second notch matched with the coil.

The present disclosure has the beneficial effects that: the coil internally nested with the flange magnetic yoke is located in a magnetic field generated by the permanent magnet of the mover assembly; and after the external circuit electrifies the coil through the FPC board, the coil and the permanent magnet interact with each other to cause the mover assembly to vibrate, relative to the stator assembly, in a vertical direction. The flange magnetic yoke is nested in the coil, and the second notches are formed in the third flanged edge of the flange magnetic yoke, in such a way, the magnetic conductivity of an overall magnetic circuit can be increased and the magnetic induction intensity on the coil can be enhanced to facilitate better interaction between the permanent magnet and the coil, thereby improving the magnetic circuit of a product, increasing the energy utilization rate and the vibration force of the product and effectively enlarging a BL value of the product, and the vibration effect is good. Furthermore, the flange magnetic yoke is conveniently connected and assembled to the coil by means of the third flanged edge, so that the operation is convenient, the structure is simple, compact and stable, and a space occupied is small, thus improving the stability, the reliability and the manufacturing yield of the product, facilitating mass production of the product and extending the application and development of the product.

In some implementation modes, the flange magnetic yoke is a hollow column; the diameter of the permanent magnet is less than the inner diameter of the flange magnetic yoke, and one end of the permanent magnet is located in the flange magnetic yoke; and the permanent magnet can move in the axial direction of the flange magnetic yoke to cause the mover assembly to vibrate.

In some implementation modes, the end, close to the coil, of the permanent magnet is provided with a pole piece.

In some implementation modes, the enclosure includes an upper enclosure and a lower enclosure, and the stator assembly is arranged on the lower enclosure.

In some implementation modes, a third slot used for mounting the FPC board is arranged on the lower enclosure.

In some implementation modes, the bottom surface of the third slot is provided with a positioning through hole.

In some implementation modes, the mover assembly is elastically connected with the upper enclosure and the lower enclosure through a spring.

In some implementation modes, a first flanged edge matched with the spring and the upper enclosure is formed on the lower enclosure.

In some implementation modes, the mover assembly includes a mass block connected with the spring, and the end, close to the coil, of the mass block is provided with a first magnetic yoke matched with the permanent magnet.

In some implementation modes, a first hole for mounting the first magnetic yoke is formed in the mass block; a fourth slot used for mounting the permanent magnet and with the slot opening facing the coil is arranged on the first magnetic yoke; and the slot opening of the fourth slot is provided with a second flanged edge.

In addition, in the technical solution of the present disclosure, unless otherwise specified, the technical solution can be realized by using conventional means in this field.

### BRIEF DESCRIPTION OF THE DRAWINGS

To describe the specific implementation modes of the present disclosure or the technical solutions in the prior art more clearly, drawings required to be used in the specific implementation modes or the illustration of the prior art will be briefly introduced below. Apparently, the drawings in the illustration below are some implementation modes of the present disclosure. Those ordinarily skilled in the art can also obtain other drawings according to these drawings without doing creative work.

FIG. 1 is an exploded view of a linear motor with a flange magnetic yoke nested in a coil provided in the embodiment of the present disclosure.

FIG. 2 is a three-dimensional diagram of a linear motor with a flange magnetic yoke nested in a coil provided in the embodiment of the present disclosure.

FIG. 3 is a cutaway view of a linear motor with a flange magnetic yoke nested in a coil provided in the embodiment of the present disclosure.

FIG. 4 is a three-dimensional diagram of an upper enclosure provided in the embodiment of the present disclosure.

FIG. 5 is a three-dimensional diagram of a lower enclosure provided in the embodiment of the present disclosure.

FIG. 6 is a three-dimensional diagram of a flange magnetic yoke provided in the embodiment of the present disclosure.

Numerals in the drawings: 1: enclosure; 11: upper enclosure; 111: insertion portion; 112: abutting surface; 113: seventh slot; 12: lower enclosure: 121: first flanged edge; 122: first slot; 123: third slot; 124: positioning through hole; 125: sixth slot; 126: first notch; 127: supporting portion; 2: mover assembly; 21: permanent magnet; 22: mass block; 221: first hole; 222: fifth slot; 23: first magnetic yoke; 231: fourth slot; 232: second flanged edge; 24: pole piece; 3: stator assembly; 31: coil; 32: flange magnetic yoke; 321: third flanged edge; 322: second notch; 33: FPC board; 331: connection portion; 4: spring; and 41: second slot.

### DETAILED DESCRIPTION OF THE EMBODIMENTS

To make the objectives, technical solutions and advantages of the present disclosure clearer, the present disclosure is further described below in detail with reference to accompanying drawings and embodiments. It should be understood that the specific embodiments described here are a part of embodiments of the present disclosure, not all the embodiments, and are only used to explain the present disclosure and not intended to limit the present disclosure. Based on the embodiments in the present disclosure, all other embodiments obtained by those of ordinary skill in the art without creative work shall fall within the protection scope of the present disclosure.

In the description of the present disclosure, it should be noted that orientations or positional relationships indicated by the terms “center”, “upper”, “lower”, “left”, “right”, “vertical”, “horizontal”, “inside”, “outside”, “two ends”, “two sides” and the like are orientations or positional relationships as shown in the drawings, and are only for the purpose of facilitating and simplifying the description of the present disclosure instead of indicating or implying that elements indicated must have particular orientations, or be constructed and operated in the particular orientations, so that these terms are not construed as limiting the present disclosure. In addition, the terms “first”, “second”, “superior”, “inferior”, “primary”, “secondary”, etc. are only used for descriptive purposes, and can be simply used to distinguish different components more clearly. It cannot be understood as indicating or implying relative importance.

In the description of the present disclosure, it should be noted that unless otherwise explicitly defined and defined, the terms “installed”, “connected” and “connection” shall be understood broadly, and may be, for example, fixed connection, or detachable connection, or integrated connection, or mechanical connection, or electrical connection, or direct connection, or indirect connection through an intermediate medium, or interconnection between two elements. Those of ordinary skill in the art can understand the specific meanings of the above terms in the present disclosure according to specific situations.

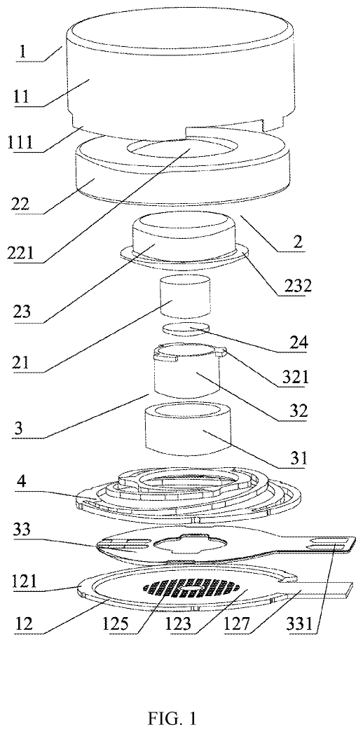

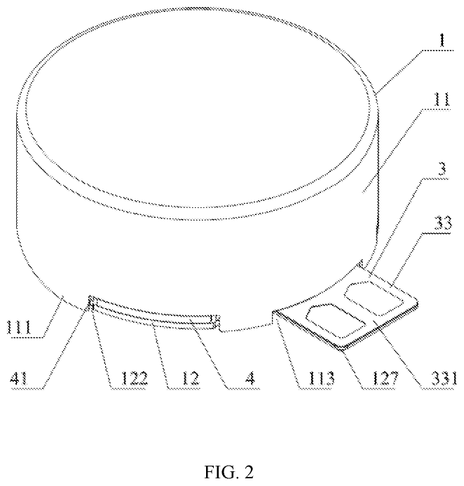

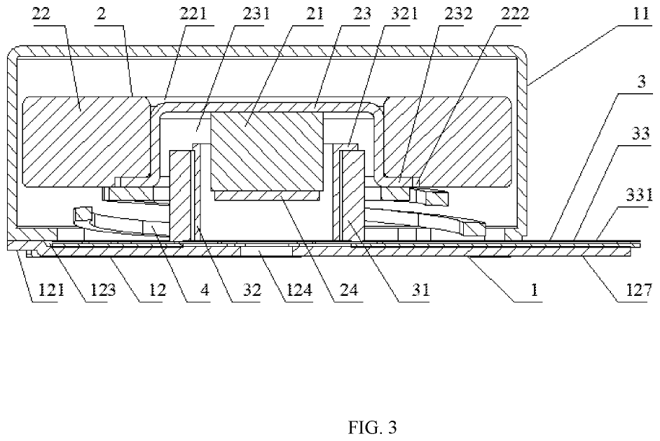

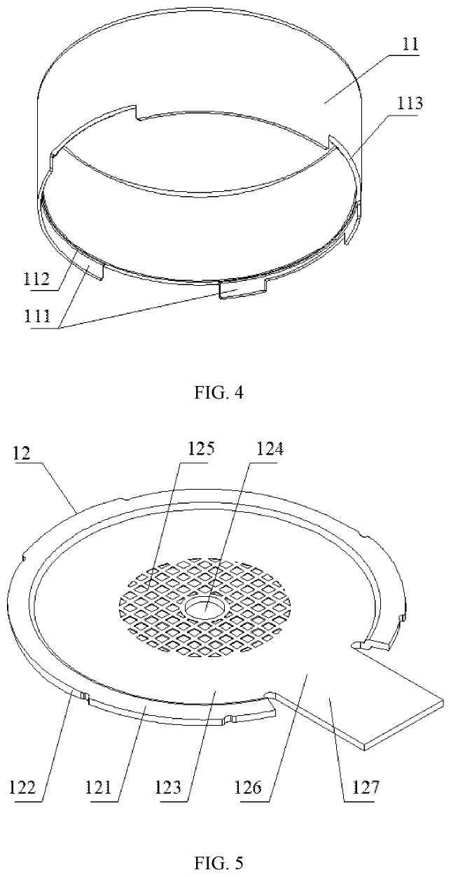

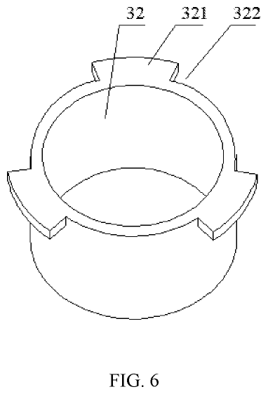

FIG. 1 is an exploded view of a linear motor with a flange yoke nested in a coil provided in the embodiment of the present disclosure. FIG. 2 is a three-dimensional diagram of a linear motor with a flange magnetic yoke nested in a coil provided in the embodiment of the present disclosure. FIG. 3 is a cutaway view of a linear motor with a flange magnetic yoke nested in a coil provided in the embodiment of the present disclosure. FIG. 4 is a three-dimensional diagram of an upper enclosure provided in the embodiment of the present disclosure. FIG. 5 is a three-dimensional diagram of a lower enclosure provided in the embodiment of the present disclosure. FIG. 6 is a three-dimensional diagram of a flange magnetic yoke provided in the embodiment of the present disclosure.

### Embodiment

As shown in FIG. 1 to FIG. 6, a linear motor with a flange magnetic yoke nested in a coil includes an enclosure 1. A mover assembly 2 and a stator assembly 3 correspondingly cooperating with the mover assembly 2 are arranged in the enclosure 1. The mover assembly 2 is generally located above the stator assembly 3. The enclosure 1 includes an upper enclosure 11 and a lower enclosure 12. The stator assembly 3 is arranged on the lower enclosure 12. The upper enclosure 11 and the lower enclosure 12 are generally connected together by means of welding. The stator assembly 3 includes a coil 31. A flange magnetic yoke 32 is nested in the coil 31. The coil 31 and the flange magnetic yoke 32 are generally fastened by means of gluing. The coil 31 is connected to an external circuit through an FPC board 33. The coil 31 and the FPC board 33 are generally connected by means of gluing or welding. The FPC board 33 and/or the coil 31 are/is generally fixed to the lower enclosure 12 by means of gluing. The mover assembly 2 is provided with a permanent magnet 21 correspondingly matched with the coil 31. The permanent magnet 21 is generally located above the coil 31. The end, close to the permanent magnet 21, of the flange magnetic yoke 32 is provided with a third flanged edge 321 matched with the coil 31. The third flanged edge 321 is provided with, in a circumferential direction thereof, a second notch 322 matched with the coil 31. There may be one, two or more second notches 322. Generally, multiple second notches 322 are uniformly distributed in the circumferential direction of the third flanged edge 321. After being electrified, the coil 31 interacts with the permanent magnet 21 to cause the mover assembly 2 to vibrate in the vertical direction. The coil 31 and the flange magnetic yoke 32 are generally hollow columns, and may also be in other suitable shapes. The flange magnetic yoke 32 may also be solid. The flange magnetic yoke 32 is conveniently connected and assembled to the coil 31 by means of the third flanged edge 321, thus improving the structural stability of the coil 31 and the reliability of connection between the coil 31 and related parts. Furthermore, the flange magnetic yoke 32 can better conduct surrounding magnetic induction lines to the coil 31 to increase the magnetic conductivity of an overall magnetic circuit and enhance the magnetic induction intensity on the coil 31. A magnetic field generated by the permanent magnet 21 can better act on the coil 31, thus increasing the interaction force, i.e., a vibration force of a product, between the permanent magnet 21 and the coil 31. Since the third flanged edge 321 of the flange magnetic yoke 32 is matched with one end of the coil 31, which will affect the magnetic induction intensity on the coil 31, the magnetic induction lines can better act on the coil 31 by means of arranging the second notches 322 on the third flanged edge 321 of the flange magnetic yoke 32, and the effect is better.

The FPC board 33 is a printed circuit board that is made of a polyimide or polyester thin film serving as a base material and has high reliability and excellent flexibility. The FPC board has the characteristics of high wiring density, light weight, small thickness and good bending performance. A magnetic yoke usually refers to a soft magnetic material that does not generate a magnetic field (magnetic induction lines), but only transmits the magnetic induction lines in a magnetic circuit. The magnetic yoke can usually be made of soft iron, A3 steel, soft magnetic alloy, a ferrite material, stainless steel or silicon steel that has relatively high magnetic conductivity. The magnetic yoke is uniformly and symmetrically distributed around the induction coil to prevent the magnetic flux leakage of the induction coil from diffusing outward and improve the efficiency of induction adding, thereby improving the utilization efficiency of the magnetic induction lines, that is, the utilization efficiency of energy. The permanent magnet 21 refers to a magnet that can maintain high remanence for a long time in an open circuit state, and is also called a hard magnet, such as magnetic steel, a neodymium magnet, a permanent magnet made of a ferrite permanent magnet material, etc., preferably the magnetic steel which has the characteristics of high hardness, high coercivity, high temperature resistance, high corrosion resistance and the like and has good permanent magnet characteristics. The permanent magnet subjected to saturation magnetization can still keep relatively high and stable magnetism within long time after an external magnetic field is removed.

During use, the coil 31 internally nested with the flange magnetic yoke 32 is located in the magnetic field generated by the permanent magnet 21 of the mover assembly 2. After the external circuit electrifies the coil 31 through the FPC board 33, the coil 31 interacts with the permanent magnet 21 under a certain ampere force. Since the coil 31 is fixed, the permanent magnet 21 moves relative to the coil 31 under a corresponding counter-acting force. In this way, the coil 31 also cuts the magnetic induction lines to cause the mover assembly 2 to vibrate, i.e., the vibration of the product, in a vertical direction relative to the stator assembly 3. The present disclosure is convenient to operate, simple, compact and stable in structure, and small in space occupied. The flange magnetic yoke 32 is conveniently connected and assembled to the coil 31 by means of the third flanged edge 321, thus improving the structural stability of the coil 31 and the reliability of connection between the coil 31 and related parts. Furthermore, the flange magnetic yoke 32 is nested in the coil 31, and the second notches 322 matched with the coil 31 are formed in the third flanged edge 321 of the flange magnetic yoke 32, in such way, the magnetic conductivity of the overall magnetic circuit can be increased and the magnetic induction intensity on the coil 31 can be enhanced to facilitate better interaction between the permanent magnet 21 and the coil 31, thereby improving the magnetic circuit of a product, increasing the energy utilization rate and the vibration force of the product and effectively enlarging a BL value of the product, and the vibration effect is good, and thus improving the stability, the reliability and the manufacturing yield of the product, facilitating mass production of the product and extending the application and development of the product. In addition, the BL value is a product of the intensity of the magnetic field and an effective cutting length of the coil. The BL value reflects the size of an ampere force of different motors under the same current. A larger BL value reflects a higher ampere force. Adjustment of a current waveform of the coil 31 can change the frequency and amplitude of the vibration of the mover assembly 2 to generate different vibration sensations. The rich vibration sensations realize various different tactile feedbacks and are applied to power sources for tactile feedbacks of intelligent equipment, and the application range of the product is enlarged.

To mount the FPC board 33 more conveniently and stably, a third slot 123 used for mounting the FPC board 33 is arranged on the lower enclosure 12, and the FPC board 33 is generally fixed to the bottom surface of the third slot 123 by means of gluing. Further, in the assembling process of the product, the lower enclosure 12 needs to be located on a certain jig at first. Then, other parts are assembled. The bottom surface of the third slot 123 is also provided with a positioning through hole 124. The FPC board 33 is also usually provided with an avoiding through hole correspondingly matched with the flange magnetic yoke 32. The coil 31 and the flange magnetic yoke 32 are usually hollow columns. An inner hole of the flange magnetic yoke 32 corresponds to the positioning through hole 124, so as to be synchronously positioned or carries out avoiding during positioning. By means of the positioning through hole 124, positioning of the lower enclosure 12 and assembling of the related parts are facilitated. The operation is easy and convenient, the precision is higher, the stability is higher, and the manufacturing yield of the product is increased.

The bottom surface of the third slot 123 may also be provided with a plurality of sixth slots 125 matched with the FPC board 33. Generally, the plurality of sixth slots 125 are mutually staggered to form a mesh. In this way, after being coated with glue, the FPC board 33 can be glued to the lower enclosure 12 more firmly.

The FPC board 33 is usually provided with a connection portion 331 extending out of the enclosure 1 to facilitate connection with the external circuit. A first notch 126 for allowing the connection portion 331 to pass through and a supporting portion 127 matched with the connection portion 331 are arranged on the lower enclosure 12. A seventh slot 113 used for allowing the supporting portion 127 and the connection portion 331 to pass through is arranged on the upper enclosure 11. In this way, the motor can be conveniently connected to the external circuit, and the structure is more compact and stabler. The FPC board 33 may also be provided with a slot matched with a lead wire of the coil 31. In this way, the structure is more compact to reduce the space occupied by the related parts, and a protection effect is achieved on the lead wire of the coil 31 to make the present disclosure safer and more reliable.

The mover assembly 2 is elastically connected with the upper enclosure 11 and the lower enclosure 12 through a spring 4. That is, the mover assembly 2 is suspended in the enclosure 1 by the spring 4. Usually, the lower end of the upper enclosure 11, the outer side edge of the spring 4 and the lower end of the lower enclosure 12 abut and are connected in sequence. In the vibration process of the mover assembly 2, the spring 4 not only has a buffer and protection effect, but also can provide certain resilience for the vibration of the mover assembly 2. A conical spring, a tower spring, a flat spring or other suitable elastic members may be adopted as the spring 4. The flat spring usually refers to a leaf spring generating perpendicular elastic deformation in a plane. For example, the flat spring is formed by scrolling an elastic material on a plane, formed by hollowing a flat elastic material, or formed by punching and cutting an elastic material. The flat spring is more compact in structure, and can reduce the volume of the product.

A first flanged edge 121 matched with the spring 4 and the upper enclosure 11 is formed on the lower enclosure 12. The upper enclosure 11 and/or the spring 4 abut(s) against and are/is connected to the first flanged edge 121, so that the operation is more convenient and the structure is stabler and firmer.

The first flanged edge 121 is provided with a plurality of first slots 122. The first slots 122 are usually located on the outer side edge of the first flanged edge 121, and are uniformly distributed in the circumferential direction of the first flanged edge 121. There may be one, two or more first slots 122 according to specific situations. Second slots 41 correspondingly matched with the first slots 122 are arranged on the spring 4. The second slots 41 are usually located on the outer side edge of the spring 4. Insertion portions 111 corresponding to the first slots 122 and the second slots 41 are arranged on the upper enclosure 11. During assembling, the insertion portions 111 are inserted into the first slots 122 and the second slots 41. In this way, the upper enclosure 11, the spring 4 and the lower enclosure 12 are connected more tightly, and the structure is more compact, stabler and more reliable. Further, the thickness of the insertion portions 111 is less than the thickness of the upper enclosure 11, so that abutting surfaces 112 are formed at intersections between the insertion portions 111 and the upper enclosure 11. By means of the abutting surfaces 112, the upper enclosure 11 can be better matched with the spring 4 or the first flanged edge 121, and the stability is higher.

The mover assembly 2 includes a mass block 22 connected with the spring 4. The mass block 22 is also called a balance weight, a vibration block, a clump weight and the like. In the vibration process, the mass block 22 can increase the vibration force of the mover assembly 2 and enhance the vibration effect via its inertia. Therefore, the mover assembly 2 can vibrate more stably and reliably. The permanent magnet 21 is arranged at the end, close to the coil 31, of the mass block 22. The permanent magnet 21 and the mass block 22 can be connected by means of gluing or welding.

The end, close to the coil 31, of the mass block 22 is provided with a first magnetic yoke 23 matched with the permanent magnet 21 and a first hole 221 for mounting the first magnetic yoke 23. A fourth slot 231 used for mounting the permanent magnet 21 and with the slot opening facing the coil 31 is arranged on the first magnetic yoke 23. The first magnetic yoke 23 is mounted in the first hole 221, and the permanent magnet 21 is mounted in the fourth slot 231, so that the connection is tighter and firmer, and the structure is more compact and stabler. A magnetic yoke usually refers to a soft magnetic material that does not generate a magnetic field (magnetic induction lines), but only transmits the magnetic induction lines in a magnetic circuit. The magnetic yoke can usually be made of soft iron, A3 steel, soft magnetic alloy, a ferrite material, stainless steel or silicon steel that has relatively high magnetic conductivity. The magnetic yoke is uniformly and symmetrically distributed around the induction coil to prevent the magnetic flux leakage of the induction coil from diffusing outward and improve the efficiency of induction adding, thereby improving the utilization efficiency of the magnetic induction lines, that is, the utilization efficiency of energy.

A second flanged edge 232 is also arranged at the slot opening of the fourth slot 231. One end of the first hole 221 is provided with a fifth slot 222 matched with the second flanged edge 232. In this way, the connection is tighter, and the structure is more compact, stabler and more reliable. In addition, the spring 4 may also be connected with the mass block 22 and the second flanged edge 232. In this way, the connection is tighter and firmer.

The end, close to the coil 31, of the permanent magnet 21 is provided with a pole piece 24. The pole piece 24 may be usually glued or welded to the permanent magnet 21. The pole piece 24 may be usually made of a soft magnetic material that does not generate a magnetic field, but only transmits magnetic induction lines in a magnetic circuit. The pole piece may restrict the magnetic field generated by the permanent magnet 21 to a certain extent to cause the magnetic induction lines to better act on the coil 31 and improve the efficiency of induction adding, thereby improving the utilization efficiency of the magnetic induction lines, that is, the utilization efficiency of energy. Therefore, the interaction force, i.e., a vibration force of a product, between the permanent magnet 21 and the coil 31 is increased.

The flange magnetic yoke 32 is a hollow column. The diameter of the permanent magnet 21 is less than the inner diameter of the flange magnetic yoke 32, and one end of the permanent magnet 21 is located in the flange magnetic yoke 32. During use, the permanent magnet 21 can move in an axial direction of the flange magnetic yoke 32 to cause the mover assembly 2 to vibrate. In this way, the structure is more compact, stabler, safer and more reliable. Further, the diameter of the fourth slot 231 is greater than the outer diameter of the coil 31. The diameter of the pole piece 24 is equal to or slightly less than the diameter of the permanent magnet 21. The upper end of the coil 31 may be located in the fourth slot 231, and the pole piece 24 and the lower end of the permanent magnet 21 may be located in the flange magnetic yoke 32. The flange magnetic yoke 32 is coaxial with the permanent magnet 21. The pole piece 24 and the permanent magnet 21 move in the axial direction of the flange magnetic yoke 32 to cause the mover assembly 2 to vibrate in the vertical direction. The utilization efficiency of the magnet induction lines is higher, and the utilization efficiency of energy is improved. The vibration effect is better, and the structure is more compact and stabler, which further reduces the volume of the product.

Under the same condition, relevant external interference factors are excluded, and the vibration forces (i.e., the relative action force between the coil 31 and the permanent magnet 21) of different products are compared: the maximum vibration force of a product without the flange magnet yoke 32 in the coil 31 is 29.55/mN, and the maximum vibration force of a product with the flange magnet yoke 32 in the coil 31 but without second notches 322 on the third flanged edge 321 of the flange magnet yoke 32 is 63.86/mN. The maximum vibration force of the present disclosure is 97.17/mN. It can be seen that the present disclosure greatly increases the vibration force of the product.

The above implementation modes are only some of the implementation modes of the present disclosure, which are only used to illustrate the technical solutions of the present disclosure, but not to limit the present disclosure. It should be understood that for those of ordinary skill in the art, those of ordinary skill in the art can also make improvements or substitutions according to the above illustration without departing from the creation concept of the present disclosure, and these improvements and substitutions shall all fall within the protection scope of appended claims of the present disclosure. In this case, all details can be replaced with equivalent elements, and materials, shapes and sizes can also be arbitrary.

What is claimed is:

1. A linear motor with a flange magnetic yoke nested in a coil, comprising an enclosure, wherein
a mover assembly and a stator assembly correspondingly cooperating with the mover assembly are arranged in the enclosure;
the stator assembly comprises the coil and an FPC board for connecting the coil with an external circuit;
the flange magnetic yoke is nested in the coil;
the mover assembly is provided with a permanent magnet correspondingly matched with the coil;
an end, close to the permanent magnet, of the flange magnetic yoke is provided with a third flanged edge matched with the coil; and
the third flanged edge is provided with, in a circumferential direction of the third flanged edge, at least one second notch matched with the coil.

2. The linear motor with the flange magnetic yoke nested in the coil according to claim 1, wherein
the flange magnetic yoke is a hollow column;
a diameter of the permanent magnet is less than an inner diameter of the flange magnetic yoke, and an end of the permanent magnet is located in the flange magnetic yoke; and
the permanent magnet moves in an axial direction of the flange magnetic yoke to cause the mover assembly to vibrate.

3. The linear motor with the flange magnetic yoke nested in the coil according to claim 1, wherein an end, close to the coil, of the permanent magnet is provided with a pole piece.

4. The linear motor with the flange magnetic yoke nested in the coil according to claim 1, wherein the enclosure comprises an upper enclosure and a lower enclosure, and the stator assembly is arranged on the lower enclosure.

5. The linear motor with the flange magnetic yoke nested in the coil according to claim 4, wherein a third slot used for mounting the FPC board is arranged on the lower enclosure.

6. The linear motor with the flange magnetic yoke nested in the coil according to claim 5, wherein a bottom surface of the third slot is provided with a positioning through hole.

7. The linear motor with the flange magnetic yoke nested in the coil according to claim 4, wherein the mover assembly is elastically connected to the upper enclosure and the lower enclosure through a spring.

8. The linear motor with the flange magnetic yoke nested in the coil according to claim 7, wherein a first flanged edge matched with the spring and the upper enclosure is formed on the lower enclosure.

9. The linear motor with the flange magnetic yoke nested in the coil according to claim 7, wherein the mover assembly comprises a mass block connected to the spring, and an end, close to the coil, of the mass block is provided with a first magnetic yoke matched with the permanent magnet.

10. The linear motor with the flange magnetic yoke nested in the coil according to claim 9, wherein
a first hole for mounting the first magnetic yoke is formed in the mass block;
a fourth slot used for mounting the permanent magnet and with a slot opening facing the coil is arranged on the first magnetic yoke; and
the slot opening of the fourth slot is provided with a second flanged edge.

11. The linear motor with the flange magnetic yoke nested in the coil according to claim 2, wherein the enclosure comprises an upper enclosure and a lower enclosure, and the stator assembly is arranged on the lower enclosure.

12. The linear motor with the flange magnetic yoke nested in the coil according to claim 3, wherein the enclosure comprises an upper enclosure and a lower enclosure, and the stator assembly is arranged on the lower enclosure.

13. The linear motor with the flange magnetic yoke nested in the coil according to claim 11, wherein a third slot used for mounting the FPC board is arranged on the lower enclosure.

14. The linear motor with the flange magnetic yoke nested in the coil according to claim 12, wherein a third slot used for mounting the FPC board is arranged on the lower enclosure.

15. The linear motor with the flange magnetic yoke nested in the coil according to claim 13, wherein a bottom surface of the third slot is provided with a positioning through hole.

16. The linear motor with the flange magnetic yoke nested in the coil according to claim 14, wherein a bottom surface of the third slot is provided with a positioning through hole.

17. The linear motor with the flange magnetic yoke nested in the coil according to claim 11, wherein the mover assembly is elastically connected to the upper enclosure and the lower enclosure through a spring.

18. The linear motor with the flange magnetic yoke nested in the coil according to claim 12, wherein the mover assembly is elastically connected to the upper enclosure and the lower enclosure through a spring.

19. The linear motor with the flange magnetic yoke nested in the coil according to claim 17, wherein a first flanged edge matched with the spring and the upper enclosure is formed on the lower enclosure.

20. The linear motor with the flange magnetic yoke nested in the coil according to claim 18, wherein a first flanged edge matched with the spring and the upper enclosure is formed on the lower enclosure.
